(19) United States
(12) Patent Application Publication
(10) Pub. No.: US 2025/0087718 A1
(43) Pub. Date: Mar. 13, 2025

(54) BIPOLAR PLATE COMPRISING SURFACE-TREATED FLOW CHANNELS

(71) Applicant: Aerostack GmbH, Dettingen an der Erms (DE)

(72) Inventors: Markus SCHUDY, Dettingen an der Erms (DE); Marcus-Benedict BUNTZ, Dettingen an der Erms (DE); Christoph ZIEGLER, Dettingen an der Erms (DE)

(21) Appl. No.: 18/883,079

(22) Filed: Sep. 12, 2024

(30) Foreign Application Priority Data
Sep. 13, 2023 (DE) 102023124675.5

(51) Int. Cl. H01M 8/0267; B64D 27/355; B64D 33/10; H01M 8/0228; H01M 8/026; H01M 8/0265; H01M 8/04007; H01M 8/04029

(52) U.S. Cl. CPC H01M 8/0267; B64D 27/355; B64D 33/10; H01M 8/0228; H01M 8/026; H01M 8/0265; H01M 8/04029; H01M 8/04059; H01M 2250/20

(57) ABSTRACT

A bipolar plate for a fuel cell having a two-phase cooling system and a fuel cell system includes a coolant inlet, a coolant outlet, and coolant channels with the coolant inlet being in fluid connection with the coolant outlet via the coolant channels. At least one inner surface of coolant inlet, coolant outlet and at least one of the coolant channels has a surface treatment to influence a flow regime of a cooling fluid along at least one inner surface and/or a phase transition of the cooling fluid.

### TECHNICAL FIELD

The disclosure herein relates in general to the technical field of aviation. In particular, the description relates to a bipolar plate comprising surface-treated flow channels and to a fuel cell system comprising such a bipolar plate.

### BACKGROUND

Fuel cells are a possible solution for the emission-free propulsion of, for example, aircraft. Polymer electrolyte membrane fuel cell stacks (PEMFC) generate power and electricity through electrochemical reaction of hydrogen and oxygen to form water. This reaction involves the generation of heat, which must be dissipated. This is achieved by liquid cooling in commercial fuel cell stacks. A potential alternative with a potential for considerable weight reduction at the system level is to replace liquid cooling with a two-phase cooling circuit. Use is made here of the latent heat of evaporation to dissipate large amounts of heat from the fuel cells. Furthermore, the high heat transfer coefficient improves the performance of the thermal management system compared to single-phase cooling. Changing the flow regime in the fuel cell stack from liquid cooling to two-phase cooling requires a specific thermal design of the flow fields.

### SUMMARY

It can be considered to be an object of the disclosure herein to improve the fluid dynamic design of the flow fields.

This object is achieved by the subject matter and embodiments disclosed herein.

According to an aspect, the bipolar plate for a fuel cell has a two-phase cooling system having the following features: a coolant inlet, a coolant outlet, and a multiplicity of coolant channels. The coolant inlet is in fluid connection with the coolant outlet via the multiplicity of coolant channels. Furthermore, at least one inner surface of coolant inlet, coolant outlet and at least one of the multiplicity of coolant channels has a surface treatment to influence the flow regime of a cooling fluid along at least one inner surface and/or a phase transition of the cooling fluid.

A fuel cell system comprising a bipolar plate in the context of the disclosure herein is a technological unit which consists of multiple components and is used to convert chemical energy into electrical energy by electrochemical reactions. It generally comprises one or more fuel cells which act as electrochemical cells and are the main component of the system. In addition, the system contains further components such as a fuel supply mechanism, an oxidizer supply mechanism, an electrolyte, electrodes with catalysts, and an electrical connection.

The fuel cell system uses a chemical reaction between a fuel and an oxidizer, typically hydrogen and oxygen, in order to generate electric power. Besides heat and electrical energy, this produces water as the reaction product, which makes the fuel cell system an environmentally friendly source of energy. The electrical energy generated can then be used to supply electrical devices, to supply vehicles or to generate power in various applications.

A two-phase cooling system in the context of the disclosure herein is a cooling solution intended for efficient dissipation of large amounts of heat by use of the phase transition from liquid to vapor. It is frequently used in situations where conventional single-phase cooling systems reach their limits and cannot provide sufficient heat dissipation, or where a particularly light, in particular weight-optimized, cooling system is of benefit.

A two-phase cooling system uses a coolant which can exist in both liquid and gaseous form at appropriate temperatures and pressures. The coolant absorbs heat from the source to be cooled and evaporates, thereby transitioning from a liquid state to a gaseous state. The resultant vapor absorbs large amounts of heat.

A two-phase cooling system generally consists of an evaporator, in which the coolant absorbs heat and evaporates, and a condenser, in which the vapor recondenses and releases the heat. The condensate is then returned to the evaporator to continue the cooling circuit.

A coolant inlet in the context of the disclosure herein is an opening or port in a cooling system, through which the cooling medium, in this case the coolant, is introduced into the system. The coolant inlet allows the controlled entry of the cooling fluid into the relevant region or components which have to be cooled.

A coolant outlet in the context of the disclosure herein is an opening or port in a cooling system, through which the cooling medium, in this case the coolant, is discharged from the system. The coolant outlet allows the controlled exit of the heated cooling fluid out of the relevant region or components in order to cool them and ensure heat exchange.

A multiplicity of coolant channels in the context of the disclosure herein are multiple channels or passages in a component or structure through which the coolant flows in order to dissipate heat. The coolant channels serve to distribute the coolant efficiently over the regions or components to be cooled and to allow heat exchange. The multiplicity of coolant channels creates a relatively large surface area for the heat transfer process, which leads to effective cooling.

The surface treatment of the inner face of coolant inlet, coolant outlet, coolant channel or combination thereof refers to the specific modification or processing of the surface in contact with the coolant. The treatment may include various methods and techniques aimed at influencing the flow regime of the coolant or improving the phase transition of the coolant.

According to one embodiment, at least a portion of the surface treatment comprises the introduction of a macrostructure, for example grooves, a mesh or sintering, on the at least one inner surface.

The advantage of such an embodiment is that the macrostructure on the inner surface of the bipolar plate allows an increased surface area and an improved flow regime of the cooling fluid. The grooves, mesh or sintering produce an enlarged contact surface between the cooling fluid and the bipolar plate, thereby ensuring efficient heat transfer. This leads to an improved cooling performance and a reduced risk of hot spots in the fuel cell. Moreover, the specific flow regime achieves a uniform distribution of the cooling fluid over the entire inner surface of the bipolar plate, which leads to improved cooling and to increased performance of the fuel cell.

According to a further embodiment, at least a portion of the surface treatment comprises the introduction of porous microparticles and/or nanoparticles. These porous particles may be selected from materials such as metals, ceramics, carbons, plastics or combinations thereof.

The advantage of this embodiment is that the porous microparticles and/or nanoparticles provide an increased surface area and improved heat transfer efficiency. The introduction of these porous particles into the surface structure of the bipolar plate considerably increases the contact area between the cooling fluid and the plate. The porous particles additionally allow more uniform distribution of the coolant by capillary transport. This allows more effective absorption and emission of heat energy, which leads to an improved cooling performance and to reduced thermal stress on the fuel cell.

Furthermore, the porous microparticles and/or nanoparticles can also help to filter or catch impurities or contaminants in the cooling fluid. By removing potentially damaging particles from the cooling system, this helps to maintain the operational performance and service life of the fuel cell.

The selection of the materials for the porous particles, such as metals, ceramics, carbons or plastics, moreover allows adaptation to specific requirements in respect of thermal stability, corrosion resistance and mechanical strength. This allows the use of the bipolar plate comprising the porous particles in a multitude of environments and operating conditions without affecting performance.

According to a further embodiment, at least a portion of the surface treatment comprises the introduction of hydrophobic and/or hydrophilic layers. These layers may be selected from metals, triels, pnictogens, chalcogens, halogens or combinations thereof.

The advantage of this embodiment is that the hydrophobic and/or hydrophilic layers allow control of the wetting properties of the bipolar plate. The introduction of these layers on the inner surfaces of the coolant inlets, coolant outlets and coolant channels allows precise control of the flow and distribution of the cooling fluid.

The use of hydrophobic layers makes the bipolar plate water-repellent. This prevents water or other liquid constituents of the cooling fluid from accumulating on the surface of the plate and causing undesirable flow blockages or corrosion. By reducing wetting properties, hydrophobic layers can also contribute to uniform and efficient flow of the coolant through the coolant channels.

On the other hand, hydrophilic layers allow improved wetting of the bipolar plate by the coolant. This can lead to a better distribution of the fluid along the inner surfaces, which improves heat transfer efficiency. Hydrophilic layers can also help to reduce the formation of gas bubbles in the cooling fluid, which further improves cooling performance.

The selection of the materials for the hydrophobic and/or hydrophilic layers from metals, triels, pnictogens, chalcogens, halogens or combinations thereof allows adaptation to the specific requirements of the fuel cell and the cooling system. The layers can be chosen to ensure optimum performance and stability according to the operating conditions and the type of cooling fluid.

Ideally, the coating also improves the electrical conductivity between the subplates of a bipolar plate.

According to one embodiment, the hydrophobic and/or hydrophilic layers are designed to reduce superheating. Furthermore, the hydrophobic and/or hydrophilic layers or the porous layers may be designed to allow better distribution of the coolant.

According to a further embodiment, hydrophobic layers are provided in the region of the coolant inlet, whereas porous microparticles and/or nanoparticles are used in the region of the multiplicity of coolant channels.

The advantage of this embodiment is that the specific application of hydrophobic layers in the region of the coolant inlet and of porous microparticles and/or nanoparticles in the region of the coolant channels leads to different effects, each effect being of great benefit.

The use of hydrophobic layers in the region of the coolant inlet results in repulsion of the cooling fluid by the surface of the bipolar plate. This prevents the fluid from accumulating at the inlet site and blocking flow. The hydrophobic layers provide for rapid and uniform flow of the coolant over the surface of the bipolar plate, thereby ensuring efficient heat exchange.

Porous microparticles and/or nanoparticles are used in the region of the multiplicity of coolant channels. These particles serve to increase the surface area of the coolant channels and to improve wetting properties. This achieves a better distribution of the cooling fluid along the channels, which leads to more efficient cooling of the bipolar plate. The porous particles promote the turbulent flow of the cooling fluid and can also help to remove gas bubbles, which improves the performance and reliability of the cooling system.

The specific use of hydrophobic layers in the region of the coolant inlet and of porous particles in the coolant channels thus achieves an optimal combination of effects. This leads to improved heat dissipation, more efficient cooling and an altogether better performance of the fuel cell.

According to a further embodiment, the coolant in the bipolar plate may comprise methanol and/or ethanol.

One advantage is that methanol and ethanol as cooling fluids have high thermal conductivity. This allows efficient dissipation of heat from the bipolar plate, which leads to better cooling and a lower operating temperature. A lower operating temperature can improve the performance and service life of the fuel cell.

Another advantage of methanol and ethanol is their good flowability and low viscosity. These properties allow a smooth flow of the cooling fluid through the coolant channels of the bipolar plate. An efficient flow ensures uniform distribution of the cooling fluid along the surface of the bipolar plate and effective heat dissipation.

According to a further embodiment, the coolant in the bipolar plate may comprise dissolved inert gas such as nitrogen. This can, for example, lead to the formation of boiling nuclei in the pores of the porous microparticles and/or nanoparticles, thereby reducing superheating.

According to another aspect, the fuel cell system comprises at least one fuel cell, a two-phase cooling system and a bipolar plate. The bipolar plate is configured such that at least one inner surface of coolant inlet, coolant outlet and at least one of the multiplicity of coolant channels has a surface treatment to influence a flow regime of a cooling fluid along the at least one inner surface and/or a phase transition of the cooling fluid.

The use of a bipolar plate having a surface treatment along the inner surfaces of coolant inlet, coolant outlet and coolant channels influences both the flow regime of the cooling fluid and the phase transition of the fluid.

One advantage is that the heat transfer between the bipolar plate and the cooling fluid is improved. The optimized flow of the cooling fluid along the inner surfaces allows efficient removal of heat, which leads to effective cooling of the fuel cell. This stabilizes the operating temperature of the fuel cell and optimizes its performance.

Furthermore, the specific influence on the flow regime and the phase transition helps to achieve a uniform distribution of the cooling fluid in the bipolar plate. This prevents the formation of hot spots, i.e., regions of increased temperature, and ensures homogeneous cooling over the entire surface of the fuel cell. This ensures uniform operation of the fuel cell, which contributes to improved performance and a longer service life.

Furthermore, the formation of gas bubbles by the surface treatment of an inner surface prevents superheating of the coolant.

According to another aspect, the aircraft is an aircraft comprising a fuel cell system as described. The fuel cell system may expressly also be used in other systems, such as motor vehicles, watercraft, spaceflight, or other units driven by a fuel cell.

The aircraft comprising the fuel cell system has the advantage of an environmentally friendly and efficient source of energy. Fuel cell systems have a low emission profile and can make aircraft operation more sustainable. The integration of the described bipolar plate having the surface treatment increases the performance of the cooling system and contributes to the reliability and efficiency of the aircraft, which ultimately contributes to more environmentally friendly and more advanced aviation.

According to a further embodiment, the bipolar plate has a preheating region which is connected from the coolant inlet to the coolant outlet via a multiplicity of coolant channels. Present in the preheating region is at least one preheating channel which serves to redirect the flow direction of the coolant before it enters the multiplicity of coolant channels. This reduces a temperature gradient along the preheating channel. In a specific embodiment, the preheating channel in the preheating region has at least one region in which the coolant flows in the opposite direction to the usual flow direction.

The advantage here is that the preheating channel in the preheating region redirects the flow direction of the coolant, thereby reducing a temperature gradient along the channel.

According to a further embodiment, at least one of the coolant channels has a variable cross section which serves to reduce the pressure gradient of a coolant along the channels and/or the backflow of the coolant.

The advantage of this bipolar plate having an efficient two-phase cooling system is that it provides an improved cooling performance. The variable cross section of at least one coolant channel, in particular all coolant channels, reduces the pressure gradient of the coolant along the channels. This allows more uniform distribution of the cooling medium and prevents undesirable backflow of the coolant.

Embodiments are coolant channels having a preheating channel present in a preheating region and coolant channels having a variable cross section. They are advantageous for cooling in a two-phase cooling system because, for example, they promote the formation of boiling initiators of the coolant.

### BRIEF DESCRIPTION OF THE DRAWINGS

Example embodiments of the disclosure herein are discussed in more detail below with reference to the appended drawings. The illustrations are schematic and not true to scale. The same reference signs denote identical or similar elements. In the figures:

FIG. 1 shows a bipolar plate;

FIG. 2 shows various embodiments of the surface treatment of the inner face of a coolant channel;

FIG. 3 shows a fuel cell system; and

FIG. 4 shows an aircraft comprising a fuel cell system.

### DETAILED DESCRIPTION

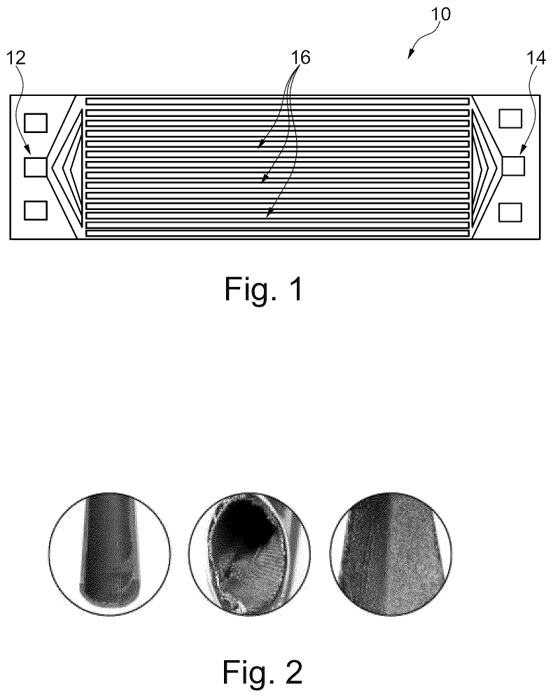

FIG. 1 shows a bipolar plate 10 for a fuel cell having a two-phase cooling system. The bipolar plate comprises a coolant inlet 12, a coolant outlet 14 and a multiplicity of coolant channels 16. The coolant inlet 12 is in fluid connection with the coolant outlet 14 via the multiplicity of coolant channels 16. It should be noted that at least one inner surface of the coolant inlet 12, of the coolant outlet 14 and of at least one of the coolant channels 16 has a surface treatment to influence the flow regime of the cooling fluid along the at least one inner surface and/or the phase transition of the cooling fluid.

FIG. 2 shows that various options are available for the surface treatment of the inner face of the coolant channels. One option is to use grooved surfaces. This method is found to work well, especially with respect to gravity.

Another common option is to use wire mesh. This technique also provides good performance. It should be particularly noted that wire meshes work well against the effect of gravity and are therefore effective.

A third surface treatment option is sintering. Sintered surfaces are particularly effective in counteracting gravity and, in this respect, achieve the best results.

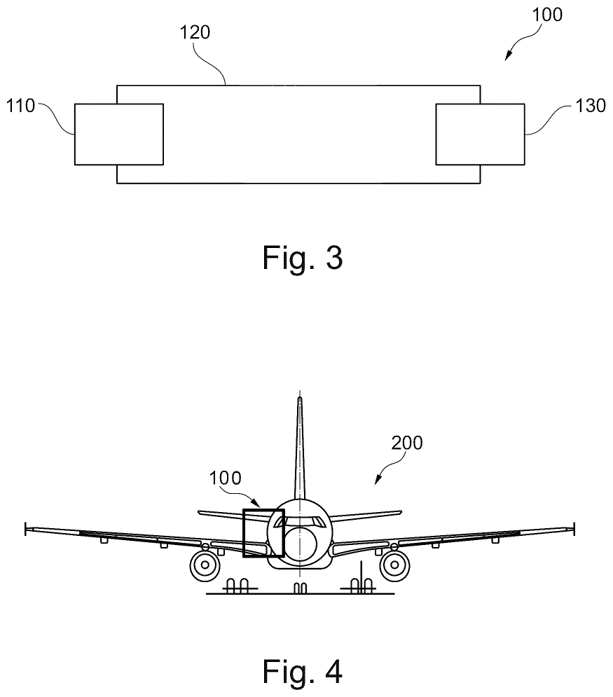

FIG. 3 shows a fuel cell system 100 consisting of multiple components, including a fuel cell 110, which may also be configured as a fuel cell stack, and a two-phase cooling system 120 and a heat exchanger 130.

The fuel cell 110 comprises a multiplicity of bipolar plates 10 (not shown) comprising a multiplicity of coolant channels 16. The surface treatment of an inner surface of coolant inlet 12, coolant outlet 14 and at least one of the multiplicity of coolant channels 16 positively influences the flow regime of the coolant along the at least one inner surface and/or a phase transition of the cooling fluid.

FIG. 4 shows an aircraft 200 comprising a fuel cell system 100 comprising a fuel cell 100 and a bipolar plate 10 present therein.

It should additionally be pointed out that “comprising” or “having” does not rule out other elements or steps, and “a”, “an” or “one” does not rule out a multiplicity. It is furthermore pointed out that features or steps that have been described with reference to one of the above example embodiments may also be used in combination with other features or steps of other example embodiments described above. Reference signs in the claims should not be interpreted as restricting.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 Bipolar plate
12 Coolant inlet
14 Coolant outlet
16 Multiplicity of coolant channels
100 Fuel cell system
110 Fuel cell
120 Two-phase cooling system
130 Heat exchanger
200 Aircraft

1. A bipolar plate for a fuel cell having a two-phase cooling system, comprising:
a coolant inlet;
a coolant outlet;
a multiplicity of coolant channels;
the coolant inlet being in fluid connection with the coolant outlet via the multiplicity of coolant channels; and
at least one inner surface of coolant inlet, coolant outlet and at least one of the multiplicity of coolant channels having a surface treatment to influence a flow regime of a cooling fluid along the at least one inner surface and/or a phase transition of the cooling fluid.

2. The bipolar plate of claim 1, wherein at least a portion of the surface treatment comprises a macrostructure on the at least one inner surface, or comprises a macrostructure selected from the group consisting of grooves, mesh, and sintering, on the at least one inner surface.

3. The bipolar plate of claim 1, wherein at least a portion of the surface treatment comprises porous microparticles and/or nanoparticles.

4. The bipolar plate of claim 3, wherein the porous microparticles and/or nanoparticles are selected from the group consisting of metals, ceramics, carbons, and plastics, or combinations thereof.

5. The bipolar plate of claim 3, wherein the porous microparticles and/or nanoparticles are adapted to reduce superheating of the cooling fluid.

6. The bipolar plate of claim 1, wherein at least a portion of the surface treatment comprises hydrophobic and/or hydrophilic layers.

7. The bipolar plate of claim 6, wherein the hydrophobic and/or hydrophilic layers are selected from the group consisting of metals, triels, pnictogens, chalcogens and halogens, or combinations thereof.

8. The bipolar plate of claim 6, wherein the hydrophobic and/or hydrophilic layers and/or porous layers are adapted to reduce superheating of the cooling fluid.

9. The bipolar plate of claim 3, wherein the hydrophobic layers are in a region of the coolant inlet and/or porous microparticles and/or nanoparticles are in a region of the at least one of the multiplicity of coolant channels.

10. The bipolar plate of claim 1, wherein the coolant comprises methanol and/or ethanol.

11. The bipolar plate of claim 1, wherein the coolant comprises dissolved inert gas.

12. A fuel cell system comprising:
at least one fuel cell;
a two-phase cooling system;
a heat exchanger;
the bipolar plate of claim 1;
at least one inner surface of coolant inlet, coolant outlet and at least one of the multiplicity of coolant channels having a surface treatment to influence a flow regime of a cooling fluid along the at least one inner surface and/or a phase transition of the cooling fluid.

13. An aircraft comprising the fuel cell system of claim 12.
